(19) United States
(12) Patent Application Publication
(10) Pub. No.: US 2001/0022593 A1
(43) Pub. Date: Sep. 20, 2001

(54) Method of menu-driven control of an external connected device in an audio/video apparatus

(76) Inventors: Jea-Yong Yoo, Seoul (KR); Byung-Jin Kim, Kyunggi-do (KR); Kang-Soo Seo, Kyunggi-do (KR); Hyung-Sun Kim, Seoul (KR); Nam-Seok Jo, Kyunggi-do (KR); Sang-Il Seo, Seoul (KR)

Correspondence Address: BIRCH STEWART KOLASCH & BIRCH, PO BOX 747, FALLS CHURCH, VA, 22040-0747, US

(21) Appl. No.: 09/747,983

(22) Filed: Dec. 27, 2000

(30) Foreign Application Priority Data
Dec. 27, 1999 (KR) 99-63020

(51) Int. Cl. G06F 3/14

(52) U.S. Cl. 345/810; 345/821

(57) ABSTRACT

The present invention relates to a method of menu-based control of an external device connected to a digital audio/video apparatus. According to the present invention, a main menu is displayed including menu items for selecting functions or operations of the external device and a menu item for obtaining a detailed menu of the external device, the main menu image being stored in a memory of the audio/video apparatus. When one of the menu items associated with the functions or operations is selected, command data corresponding to the selected menu item are transmitted to have the external device perform the corresponding operation. When a menu item for obtaining the detailed menu of the external device is chosen, a menu image of the detailed menu is read out from the memory and is then displayed. Information provided by the external device is requested from the detailed menu. This invention allows a user to conveniently, centrally examine and execute various operations or functions of external devices such as a DVD player that are connected to a central digital audio/video apparatus without the direct access to the external devices.

### BACKGROUND OF THE INVENTION

1. Field of the Invention

The present invention relates to a method of menu-based control of external devices that are connected to a digital audio/video apparatus, and more particularly, to a method of displaying various menu items associated with functions or operations of an external device like a digital versatile disc (hereinafter DVD) player on the displaying unit of a digital audio/video apparatus, and of remotely executing a desired function or operation of the external device by selection of the corresponding menu item on the displaying unit.

2. Description of the Related Art

An analog audio/video apparatus of the conventional arts does not have communication means with which operations or functions on external audio/video devices that are connected to the audio/video apparatus can be activated or controlled remotely on the audio/video apparatus. Therefore, in order to activate or execute the functions or operations of such an audio/video apparatus, a user should enter a control key that corresponds to the desired function or operation through a control unit dedicated to the external device.

Recently, it has been considered that disc players such as CD player and MD player will be equipped with a digital interface like the IEEE 1394 through which the functions or operations of each external digital device connected to a disc player are controlled by communication of data and commands between them.

On the other hand, the standardization on the detailed specifications of the DVD has been in progress. The DVD player is expected to be widely used in connection with a digital television through the IEEE 1394 interface in the near future. In this case, it is possible and desirable that retrieval of contents of the DVD and the execution of operations or functions of the DVD player are requested by selecting menu items on the displaying unit of the digital television that is connected to the DVD player.

To accomplish this, the method of displaying the menu items associated with operations or functions of the DVD player on the displaying unit of the digital television, and remotely executing the operations or functions in response to the selection of the corresponding menu items should be specified in detail and standardized. Because the digital television still does not support such a method, the application of the method to a digital television is preferable to enhance the convenience of users.

### SUMMARY OF THE INVENTION

It is therefore a primary object of the present invention to provide a method of displaying various menu items on a displaying unit of a digital audio/video apparatus like digital television, each menu item associated with each of the functions or operations provided by an external device that is connected to the digital audio/video apparatus through the IEEE 1394 interface, and of remotely executing a desired function or operation of the external device in response to selection of the corresponding menu item on the displaying unit.

The method of menu-based remote control of an external device that is connected to an audio/video apparatus according to the present invention, comprises the steps of: displaying a menu image including menu items associated with functions or operations of the external device and menu items for obtaining the detailed menu of the external device, the menu image being stored in a memory in the audio/video apparatus; transmitting command data to the external device when a menu item associated with a desired function or operation is selected from the menu, and displaying a menu image of the detailed menu, which has been stored in the memory in the audio/video apparatus, in response to the selection of a menu item associated with the detailed menu.

### BRIEF DESCRIPTION OF THE DRAWINGS

The accompanying drawings, which are included to provide a further understanding of the invention, illustrate the preferred embodiments of this invention, and together with the description, serve to explain the principles of the present invention.

In the drawings:

FIG. 1 is a partial block diagram of a digital television embodying the present invention;

FIGS. 2A and 2B show a menu image for DVD operations and a menu image for of detailed functions of a DVD player on a digital television embodying the present invention, respectively;

FIG. 3 is a flowchart of the method of menu-based control of a DVD player according to the present invention; and

FIG. 4 shows the format of control commands signifying the play operation of a DVD player according to the present invention.

### DESCRIPTION OF THE PREFFERRED EMBODIMENT

Hereinafter, a preferred embodiment of the present invention will be described in detail referring to the accompanying drawings.

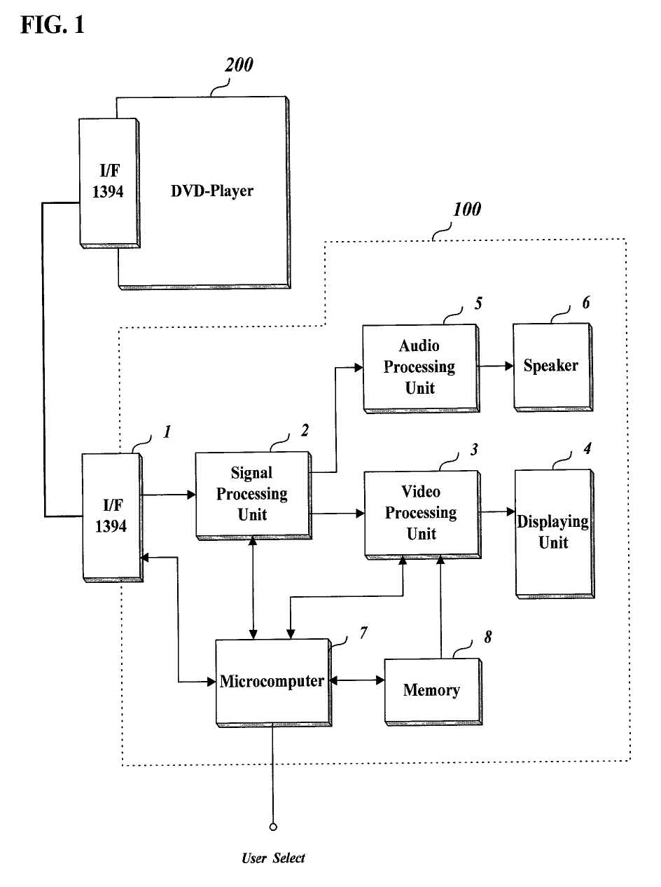

FIG. 1 shows a partial block diagram of a digital television embodying the present invention. The digital television 100 comprises an IEEE 1394 interface 1 through which it is connected to a DVD player 200; a signal processing unit 2 for decoding audio/video data from data stream that are received from the DVD player 200; an audio signal processing unit 5 for producing analog audio signal from the audio data stream decoded by the signal processing unit 2; a speaker 6 for generating sounds from the analog audio signal; a video processing unit 3 for producing display video signal from the video data stream; a displaying unit 4 for displaying the video signal produced by the video processing unit 3; a microcomputer 7 for controlling the operations of the constituting components above; and a memory 8 for temporarily storing data required for the control operations of the microcomputer 7 and storing a menu image including menu items associated with functions or operations of the DVD player 200 and another menu image including detailed menu items of the DVD player 200.

In response to user's request of a main menu image including menu items associated with functions or operation of the DVD player 200, the microcomputer 7 reads image data for a menu of operations of the DVD player 200 from the memory 8 and then sends the image data to the video processing unit 3 such that the menu is displayed on the displaying unit 4. When a menu item is selected from the main menu to obtain detailed menu items, image data for the detailed menu is read out from the memory 8, and the detailed menu is then displayed on the displaying unit 4 under control of the microcomputer 7. The men-driven operations for playing a DVD loaded in the DVD player 200 are described below in detail.

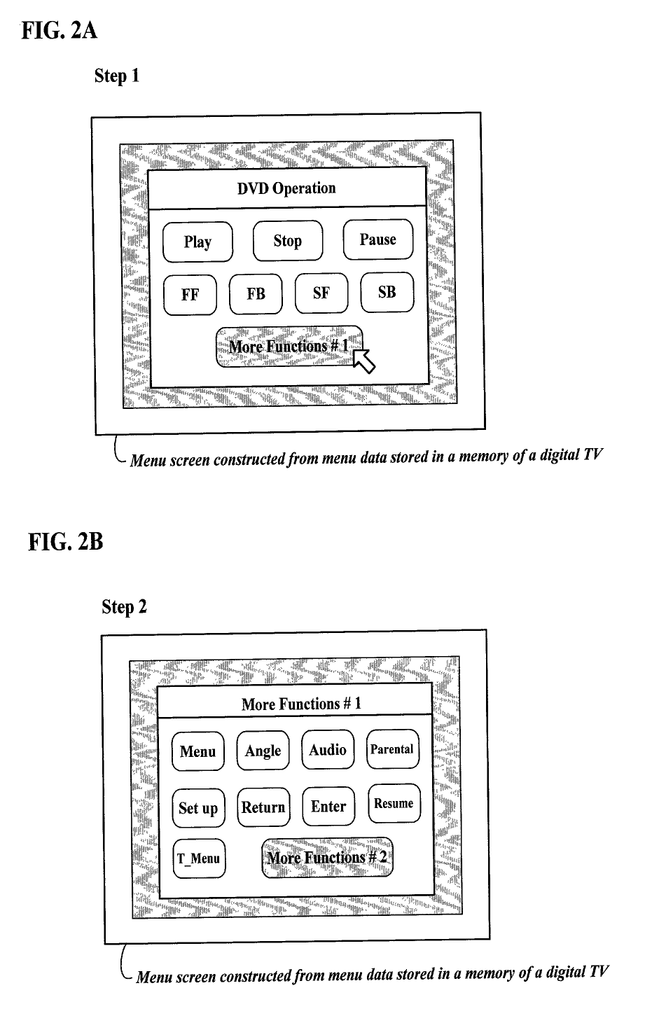

As shown in FIG. 2A, a main menu consists of menu items for basic operations of the DVD player 200 such as PLAY, STOP, and PAUSE and a menu item (MORE FUNCTIONS #1) for obtaining a detailed menu. As shown in FIG. 2B, the detailed menu image includes menu items a menu item (MENU) for obtaining a list of chapters of a particular title on the DVD, a menu item (T_MENU) for obtaining a list of titles on the DVD, a menu item (SETUP) for obtaining the set-up information stored in the memory of the DVD player 200, and a menu item (MORE FUCTION #2) for obtaining another detailed menu.

A user can choose and execute a desired operation or function of the DVD player 200 from the main menu and detailed menu on the digital television 100. The operations for the menu-based request of playback of a DVD loaded in the DVD player 200 are described below in detail.

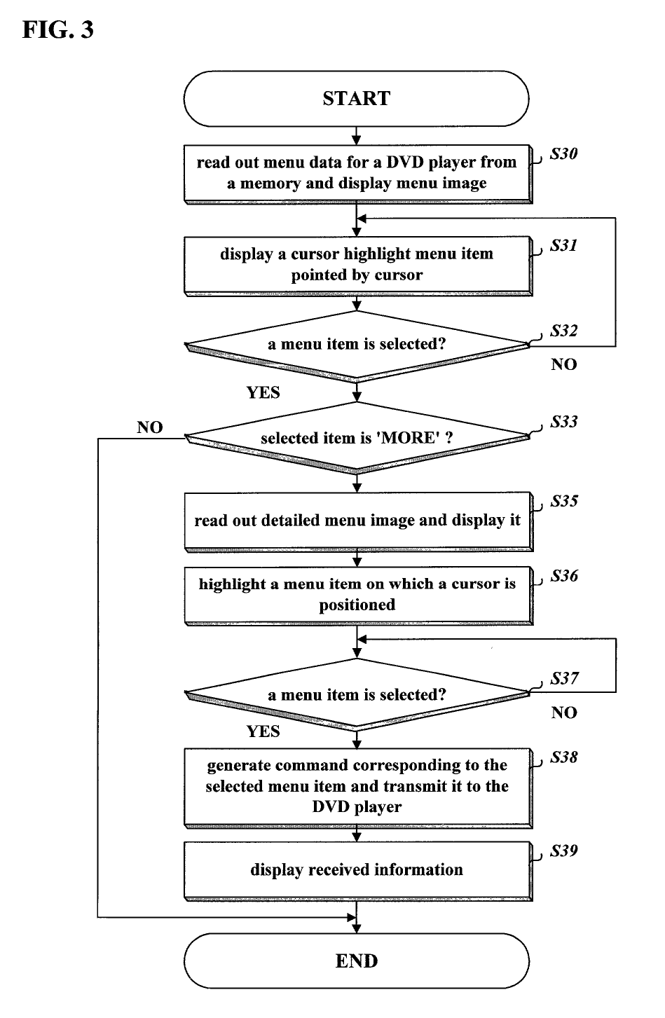

FIG. 3 is a flowchart showing how the playback of a DVD on the DVD player 200 are selected and executed from the main menu image on the digital television 100.

Once a user enters an input key signifying the display of the main menu image including menu items for functions or operations of the DVD player 200, the digital television 100 is entered into a menu mode for the DVD player 200 by the microcomputer 7. Menu data required to display the main menu image are read out from the memory 8 and are then sent to the video processing unit 3 which generates a video signal from the menu data such that the main menu image is displayed on the displaying unit 4, as shown in FIG. 2A (S30).

At this time, in order to help a user select a menu item from the main menu, the microcomputer 7 re-generates data required to display the main menu image such that the cursor pointed by a remote pointing device is displayed on the main menu image and that the menu item over which the cursor is positioned is highlighted (S31) . This is accomplished by using position data of respective areas of the menu items on the main menu image, the position data being stored in the memory 8.

In order to enable the highlight operation, the microcomputer 7 keeps tracking the position of the cursor on the menu image. When the cursor has been moved to another menu item by a user with a remote pointing device, the menu item is determined and highlighted. When a selection key is inputted while the cursor has been positioned over that menu item (S32) the microcomputer 7 determines which menu item is selected by examining the current position of the cursor. For example, if the PLAY menu item for play of the DVD loaded in the DVD player 200 is selected, a corresponding command for DVD playback is transmitted to the DVD player 200 through the interface 1.

In response to the command for playback, the DVD player 200 reads out data from the DVD and then transmits the data stream to the digital television 100. Once the data stream is received through the interface 1, the data stream is processed and decoded in order by the signal processing unit 2, the video processing unit 3, and the audio signal processing unit 5 under control of the microcomputer 7 such that the audio and video signals are inputted to the speaker 6 and the displaying unit 4, respectively.

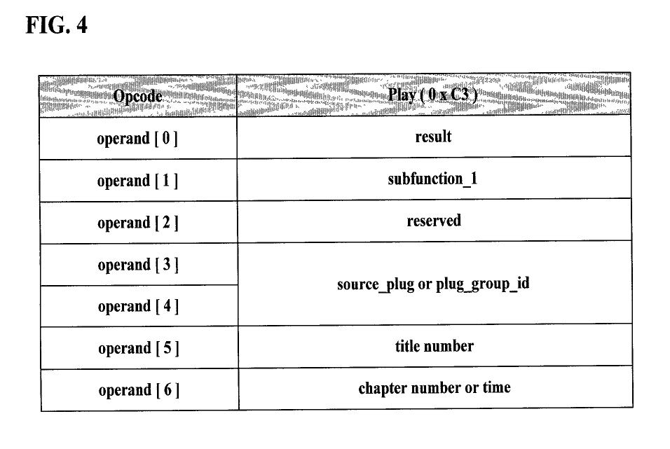

An example of the command format for the play operation of the DVD player 200 is shown in FIG. 4. To be specific, the play command consists of an operation code of 0×C3 and seven operands: operands [1]-[4] for designating which reproduction mode is requested and operands [5]-[6] for designating the contents of the DVD to playback. The contents are designated by title or chapter number, or the time

When a menu item ‘More’ for obtaining a detailed menu is selected from the main menu shown in FIG. 2A (S33), the microcomputer 7 reads out menu data from the memory 8 and sends the menu data to the video processing unit 3 such that the detailed menu image of FIG. 2B is displayed on the displaying unit 4 (S35).

On the detailed menu image, the position of the cursor is tracked by the microcomputer 7 so that when the cursor has been moved and positioned over another menu item, that menu item is highlighted differently from other menu items (S36). As in the main menu image, position data of respective areas of the menu items on the detailed menu image are read out from the memory 8 and used to determine the menu item over which the cursor is positioned.

When a menu item is selected from the detailed menu shown in FIG. 2B (S37), the microcomputer 7 generates command data corresponding to the selected menu item and transmits the command data to the DVD player 200 (S38). For example, if a user selects SETUP menu item to examine the setup environment of the DVD player 200, the microcomputer 7 transmits predefined command data to the DVD player 200 to obtain information about the setup environment. Receiving information about the setup environment from the DVD player 200, the microcomputer 7 displays information (S39) about the setup environment on the displaying unit 4 in an appropriate format.

In the case where the menu item that a user selects is associated with the request of playback information written on the DVD, not in the memory 8, for example, if T_MENU item or MENU item is selected, data related to the request, e.g., a list of titles or chapters, are read out from the DVD and are then displayed on the displaying unit 4 after an appropriate format conversion.

Accordingly, the present invention enables a user of a digital apparatus like a digital television to conveniently request and execute various operations or functions of external digital devices that are connected to the digital apparatus without the direct control of or access to the external digital devices.

The foregoing is provided only for the purpose of illustration and explanation of the preferred embodiments of the present invention, so changes, variations and modifications may be made without departing from the spirit and scope of the invention.

What is claimed is:

1. A method of menu-based remote control of an external device that is connected to an audio/video apparatus, comprising the steps of:
(a) displaying a main menu image including menu items for selecting functions or operations of said external device and menu items for obtaining a detailed menu of said external device, the main menu image being stored in a memory of said audio/video apparatus; and
(b) transmitting command data to said external device, in response to the selection of one of the menu items associated with functions or operations of said external device, and/or displaying a menu image of the detailed menu which has been stored in said memory when one of the menu items for obtaining the detailed menu is selected.

2. A method according to claim 1, wherein a menu item on the main menu image displayed in said step (a) over which the cursor is positioned is displayed differently from other menu items.

3. A method according to claim 2, wherein the menu item over which said cursor is positioned is displayed differently from other menu items based on information about the positions of respective areas of menu items on said menu image, said information being stored in a memory of said audio/video apparatus.

4. A method according to claim 1, wherein in said step (b), which menu item has been selected is determined based on the position of a cursor on said main menu image the instant that a selection key is inputted by a user.

5. A method according to claim 1, further comprising the step of transmitting to said external device command data in response to the selection of one of menu items on said detailed menu image displayed in said step (b).

6. A method according to claim 5, wherein said command data is transmitted to request and obtain information of said external device 7. A method according to claim 5, wherein said command data is transmitted to request and obtain information stored in a disk-type medium loaded in said external device
